(19) United States
(12) Patent Application Publication
(10) Pub. No.: US 2015/0192656 A1
(43) Pub. Date: Jul. 9, 2015

(54) RECEIVED SIGNAL DIRECTION DETERMINATION IN USING MULTI-ANTENNAS RECEIVERS

(71) Applicant: QUALCOMM Incorporated, San Diego, CA (US)

(72) Inventors: Benjamin A. WERNER, San Carlos, CA (US); Amir A. EMADZADEH, Santa Clara, CA (US); Sai Pradeep VENKATRAMAN, Santa Clara, CA (US); Sundar RAMAN, Fremont, CA (US)

(73) Assignee: QUALCOMM Incorporated, San Diego, CA (US)

(21) Appl. No.: 14/151,540

(22) Filed: Jan. 9, 2014

(51) Int. Cl. G01S 3/46

(52) U.S. Cl. CPC G01S 3/46

(57) ABSTRACT

Disclosed are systems, apparatus, devices, methods, media, products, and other implementations, including a method that includes determining a phase difference for a wireless signal detected by a first of at least two antennas of a receiver and by a second of the at least two antennas, determining an orientation of the receiver based on information obtained from one or more sensing devices coupled to the receiver, and determining a direction, relative to an external frame of reference, at which the wireless signal arrives at the receiver based on the determined phase difference and the orientation of the receiver determined from the information obtained from the one or more sensing devices coupled to the receiver.

### BACKGROUND

Some mobile devices include wireless receivers (e.g., GPS receivers, WWAN or WLAN receivers, etc.) comprising a single antenna. A single antenna to enable obtaining a single sample in space generally does not allow determination of the direction of an incoming signal. An observation of the direction of a signal can be used for various purposes, such as validating that a reflection is not being observed on a GNSS signal, or helping to determine the floor location of a device based on signal received from an access point (AP) within a multi-floor building. Devices with two antennas spaced sufficiently apart can sense the angle of arrival of a signal with respect to one axis of the body. However, a mobile device's attitude is not constrained to be in any particular direction with respect to an external reference frame, such as the horizon. This makes it difficult to determine the angle of elevation from which a signal arrives at the receiver without more information.

### SUMMARY

Disclosed herein are methods, systems, apparatus, devices, products, media and other implementations, including a method that includes determining a phase difference for a wireless signal detected by a first of at least two antennas of a receiver and by a second of the at least two antennas, determining an orientation of the receiver based on information obtained from one or more sensing devices coupled to the receiver, and determining a direction, relative to an external frame of reference, at which the wireless signal arrives at the receiver based on the determined phase difference and the orientation of the receiver determined from the information obtained from the one or more sensing devices coupled to the receiver.

Embodiments of the method may include at least some of the features described in the present disclosure, including one or more of the following features.

Determining the orientation of the receiver may include obtaining a measurement indicative of the orientation of the receiver from an inertial sensor including one or more of, for example, an accelerometer, a magnetometer, a gyroscope, and/or any combination thereof.

The one or more sensing devices may include an image capturing unit, and determining the orientation of the receiver may include capturing an image of a scene by the image capturing unit, identifying one or more features, appearing in the captured image, associated with known orientations relative to a frame of reference, and determining the orientation of the receiver based, at least in part, on the known orientations, relative to the frame of reference, respectively associated with the one or more identified features, and based on respective image orientations of the identified one or more features relative to another frame of reference associate with the image capturing unit.

The wireless signal may include one of, for example, a satellite signal, or a terrestrial wireless signal from a terrestrial access point.

Determining the direction, relative to the external frame of reference, at which the wireless signal arrives at the receiver may include determining an angle of elevation between the receiver and a wireless node transmitting the wireless signal, and determining an uncertainty value associated with the determined angle of elevation based on the orientation of the receiver determined based on the information obtained from the one or more sensing devices.

The uncertainty value may be proportional to an angle between a line defined by the first and second of the at least two antennas, and a zenith in a horizontal coordinate system.

The orientation of the receiver may be indicated with respect to a line defined by the first and second of the at least two antennas.

The receiver and the one or more sensing devices may be housed in a wireless device.

The method may further include determining, based on the direction, relative to the external frame of reference, at which the wireless signal arrives at the receiver and on location information for the receiver, whether the wireless signal is a reflection of a source signal.

The method may further include determining, based on the direction, relative to the external frame of reference, at which the wireless signal arrives at the receiver, a current floor within a multi-floor building where the receiver is located.

The method may further include determining, based on the direction, relative to the external frame of reference, at which the wireless signal arrives at the receiver and on location information for the receiver, an altitude at which the receiver is located.

The method may further include modifying an effective antenna pattern for the at least two antennas of the receiver based on the determined direction, relative to the external frame of reference, at which the wireless signal arrives at the receiver.

In some variations, a mobile device is disclosed that includes one or more sensing devices, a receiver including at least two antennas, and a controller. The controller is configured to, when operating, cause operations including determining a phase difference for a wireless signal detected by a first of the at least two antennas of the receiver and by a second of the at least two antennas, determining an orientation of the receiver based on information obtained from the one or more sensing devices coupled to the receiver, and determining a direction, relative to an external frame of reference, at which the wireless signal arrives at the receiver based on the determined phase difference and the orientation of the receiver determined from the information obtained from the one or more sensing devices coupled to the receiver.

Embodiments of the mobile device may include at least some of the features described in the present disclosure, including at least some of the features described above in relation to the method.

In some variations, a processor readable media is disclosed. The processor readable media is programmed with an instruction set executable on a processor that, when executed on the processor, causes operations that include determining a phase difference for a wireless signal detected by a first of at least two antennas of a receiver and by a second of the at least two antennas, determining an orientation of the receiver based on information obtained from one or more sensing devices coupled to the receiver, and determining a direction, relative to an external frame of reference, at which the wireless signal arrives at the receiver based on the determined phase difference and the orientation of the receiver determined from the information obtained from the one or more sensing devices coupled to the receiver.

Embodiments of the processor-readable media may include at least some of the features described in the present disclosure, including at least some of the features described above in relation to the method, and the mobile device, and the apparatus.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As used herein, including in the claims, “or” or “and” as used in a list of items prefaced by “at least one of” or “one or more of” indicates that any combination of the listed items may be used. For example, a list of “at least one of A, B, or C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, or C” may also include AA, AAB, AAA, BB, etc.

As used herein, including in the claims, unless otherwise stated, a statement that a function, operation, or feature, is “based on” an item and/or condition means that the function, operation, function is based on the stated item and/or condition and may be based on one or more items and/or conditions in addition to the stated item and/or condition.

Other and further objects, features, aspects, and advantages of the present disclosure will become better understood with the following detailed description of the accompanying drawings.

### BRIEF DESCRIPTION OF THE DRAWING

FIG. 1 is a schematic diagram of an example operating environment that includes a receiver configured to determine direction of a signal.

FIG. 2 is another schematic diagram of another example operating environment in which a device with a receiver configured to determine direction of an arriving signal operates.

FIG. 3 is a schematic diagram of an example mobile device.

FIG. 4 is a flowchart of an example procedure to determine signal direction with respect to an external frame.

FIG. 5 is a schematic diagram of a further example operating environment that includes a receiver device configured to determine direction of a signal.

FIG. 6 is a schematic diagram of an additional example operating environment that includes a receiver device configured to determine direction of a signal.

FIG. 7 is a schematic diagram of an example computing system.

Like reference symbols in the various drawings indicate like elements.

### DESCRIPTION

Described herein are systems, apparatus, devices, methods, products, media, and other implementations, including a method that includes determining a phase difference for a wireless signal detected by a first of at least two antennas of a receiver (e.g., of a mobile device such as a wireless phone) and by a second of the at least two antennas, determining an orientation of the receiver based on information obtained from one or more sensing devices (e.g., accelerometer, gyroscope, magnetometer, etc.) coupled to the receiver, and determining a direction, with respect to an external frame of reference, at which the wireless signal arrives at the receiver based on the determined phase difference and the orientation of the receiver determined from the information obtained from the one or more sensing devices coupled to the receiver. In some embodiments, the determined direction can be compared to an expected direction of arrival of the signal (assuming the signal's source, e.g., a satellite, and the receiver itself are located at a known or estimated positions) to perform multi-path signal analysis in order to, for example, determine whether the received signal arrived directly from the source, or corresponds to a copy of the signal travelling through another path. The determined direction of the signal can also be used, in some embodiments, to enable altitude computation and/or determination a floor of a multi-floor structure at which the receiver is located.

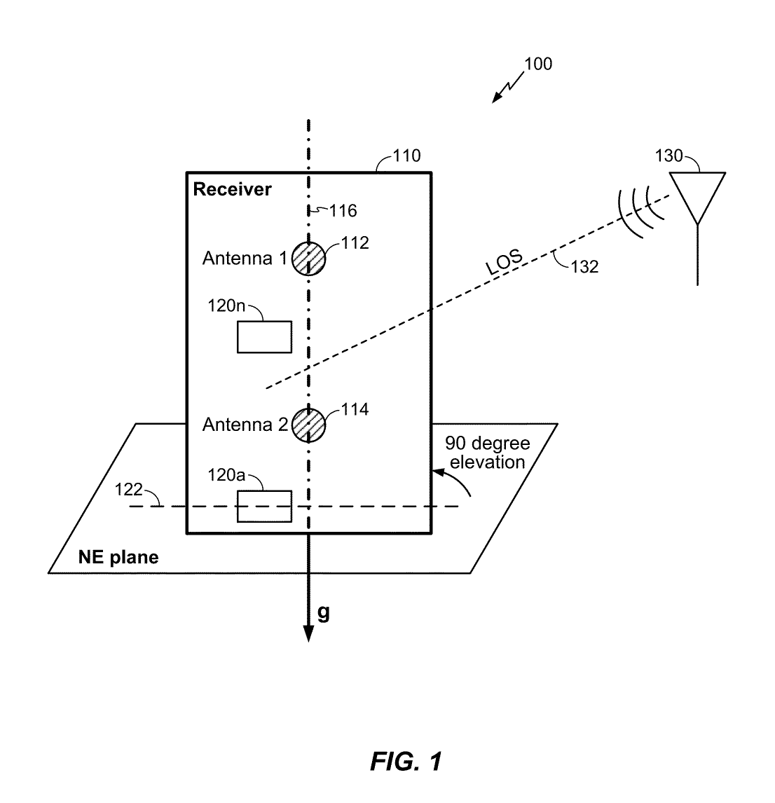

Thus, with reference to FIG. 1, a schematic diagram of an example operating environment 100 that includes a receiver 110 configured to determine direction of a signal is shown. In some embodiments, the receiver 110 may be a part of (e.g., housed in) a mobile device (e.g., a handheld wireless phone, or some other portable device). The receiver 110 includes at least two antennas 112 and 114 separated/displaced from each other by a distance sufficient to enable determining a phase difference resulting from detection of an incoming wireless signal 132, transmitted from a wireless transmitter/node 130 (e.g., a satellite, an access point such as a WiFi access point, a cellular base station, etc.) by the at least two antennas 112 and 114. In some embodiments, the distance between the at least two antennas 112 and 114 of the receiver 110 may be equal to at least λ/4, where λ corresponds to the wavelength of the wireless signal transmitted by the wireless transmitter 130 and configured to be detected by either of the at least two antennas 112 and 114. More particularly, because the at least two antennas are spatially separated from each other, instances of a signal 132 transmitted from the transmitter/node 130 will be detected at each of the at least two antennas at slightly different times. Upon correlating one instance of the detected signal (at one antenna) with a replica of the signal, a small phase difference between the two signals at their respective antennas is observed. That phase difference implies a signal direction with respect to the axis of sensitivity formed by the vector difference of the two antenna elements.

As also shown in FIG. 1, the receiver 110 further includes one or more sensing devices 120 (e.g., inertial/orientation sensors) that may be used to determine some aspects of the orientation of the multi-antenna receiver, to thus enable determination of the direction at which a wireless signal is received at the antenna. The one or more sensing devices housed at, and/or coupled to, the receiver 110 are configured to perform measurements, based on which an orientation (relative or absolute) of the receiver 110 may be determined. The one or more sensing devices 120 with which orientation of the receiver may be determined may include, for example, an accelerometer, a magnetometer, and/or a gyroscope. In the example of FIG. 1, two sensing devices, 120a and 120n, are shown. However, additional or fewer sensing devices may be used.

Based on the orientation determined from the measurements performed by the one or more sensing device 120 and on the signal phase difference determined from the detection of the signal by the receiver 110's at least two antennas 112 and 114 (and/or additional antennas), a direction of the signal (relative to an external frame of reference, such as the direction of gravity) can be derived. For example, using the determined/computed orientation of the receiver 110, together with phase difference information determined from the detection of an incoming wireless signal by the at least two antennas 112 and 114 of the receiver 110, an angle of arrival of the signal 132 with respect to, for example, a line (marked as the dashed line 116) that is defined by the receiver's antennas (e.g., a line connecting the centers of the at least two antennas of the receiver) is derived. The angle of arrival can also be computed relative to some external or global frame of reference.

Consider a situation in which the one or more sensing devices 120a-n include an accelerometer (for example, the sensing device 120a). In some embodiments, the accelerometer 120a may be a 3-D accelerometer implemented, for example, based on micro-electro-mechanical-system (MEMS) technology. The accelerometer may also be implemented using, for example, three (3) 1-D accelerometers. The accelerometer 120a is configured to sense/measure linear motion, i.e., translation in a plane, such as a local horizontal plane, that can be measured with reference to at least two axes (and thus the receiver's motion in a Cartesian coordinate space (x,y,z) can be derived). The accelerometer 120a is further configured to measure the direction of gravity acting on the accelerometer 120a, and thus configured to enable determination of the accelerometer's tilt, and by extension the tilt of the receiver 110 to which the accelerometer is coupled or is housed in.

When the accelerometer 120a is secured to the receiver 110 so that its position relative to the receiver 110 is fixed, and the receiver 110 positioned in a substantially fixed position (e.g., the receiver is held or placed so that it is substantially stationary), then based on the measurement by the accelerometer indicating the direction of gravity, the angle between, for example, one of the axes of the accelerometer 120a (e.g., a reference axis 122 of the accelerometer 120a as depicted in FIG. 1) and the direction of gravity can be determined Because the relationship between that reference axis 122 and the line 116 defined by the at least two antennas is also known (in the example of FIG. 1, the axis 122 is illustrated as being at a 90° angle relative to the line 116), the tilt of the receiver 110 relative to the direction of gravity can be determined. Using the determined orientation of the receiver 110, and a determined phase difference (for the signal detected by the at least two antennas 112 and 114 in the example of FIG. 1), a direction of the incoming detected signal relative to the receiver (e.g., an angle of arrival) can thus be determined

In the example of FIG. 1, with the receiver 110 oriented in a direction substantially parallel to the direction of gravity, the elevation (i.e., the angle formed by the line of sight to an object, such as a satellite or a terrestrial transmitter, and a horizontal plane) directly corresponds to the angle of arrival of the signal 132. As further shown in FIG. 1, in this particular example the elevation of the axis of sensitivity (formed by the two antenna elements) in that picture is 90 degrees. Particularly, an angle θ formed between a line V^{l}, corresponding to the line defined by the signal 132 (transmitted from the transmitter 130), and a vector formed as the difference between the positions of the at least two antennas 112 and 114 (denoted as a vector S^{l} representing the vector in the antennas frame of reference, l), may be determined based on the dot product of the two vectors, namely:

θ=cos⁻¹(V^{l}·S^{l})

When the vector S^{l} is substantially parallel to the vector g^{l} (i.e., the gravity vector, represented in the antennas' frame of reference l), as may be determined from the dot product of S^{a} and g^{a} (i.e., V^{a}·S^{a}, performed in the accelerometer's frame of reference), the angle of arrival θ, corresponds to the elevation with respect to the transmitter 130. Thus, in embodiments in which the line formed by the antennas is parallel to the direction of gravity, the angle of arrival can be determined with relatively high degree of accuracy depending on the ability to determine phase differences of the two antennas. If the at least two antennas are not oriented so that the line formed by them is parallel to the direction of gravity, a degree of uncertainty of the elevation emerges as the antennas' angle from zenith gets larger. Thus, in some embodiments, determining the direction at which the wireless signal arrives at the receiver may include determining an angle of elevation between the receiver 110 and a wireless node 130 (e.g., a satellite or a terrestrial access point) transmitting the wireless signal 132, and determining an uncertainty value associated with the angle of elevation based on the orientation of the receiver (determined based on the information obtained from the one or more sensing devices of the receiver). The uncertainty value, in such embodiments, may be a function of an angle between the line 116 defined by the first and second of the at least two antennas, and a zenith in a horizontal coordinate system. For example, if the angle difference between zenith and the axis of sensitivity is φ, and the observed angle of arrival with respect to the axis of sensitivity of the two antennas is λ, then the actual elevation of arrival can be anywhere between λ−φto λ+φ. The uncertainty associated with the angle of elevation diminishes in embodiments where the receiver includes more than two antennas. For example, in situations where there are more than two antennas, there would be increased likelihood of multiple antenna-pair arrangements (or a linear combinations of antenna pairs) that are sensitive in the upward direction.

The orientation of the receiver 110 may also be determined from measurement(s) obtained via other types of inertial sensing devices, from image data obtained via an onboard image capturing device coupled to the receiver, etc. For example, in some embodiments, one of the one or more sensing devices 120a-n may include a magnetometer. Magnetometers are configured to measures a magnetic field intensity and/or direction, and may, in some embodiments, measure absolute orientation with respect to the magnetic north, which can be converted to an orientation value with respect to true north. For example, the magnetometer may include three separate orthogonal magnetometer-type sensors that measure components of the magnetic field in three dimensions. In situations where the magnetometer has been calibrated to establish the true north magnetic field, the absolute orientation of the magnetometer, and thus of the receiver 110 comprising the magnetometer may be determined. In some situations, measurements performed with only a magnetometer can provide at least partial orientation of the device (generally with one remaining degree of freedom where the device rotates around the magnetic field vector). In some situations, when measurements to determine a device's orientation are performed using both a magnetometer and an accelerometer, the device's orientation can generally be fully determined (assuming the measurements are not performed at a magnetic pole, where the gravity and magnetic fields coincide). When measurements from both a magnetometer and an accelerometer are available, the uncertainty of arrival elevation angle would generally no longer depend on the device orientation's.

In some implementations, MEMS-based magnetometer may be used. Such MEMS-base sensors may be configured to detect motion caused by the Lorentz force produced by a current through a MEMS conductor. Other types of magnetometers, including such magnetometer as, for example, hall effect magnetometers, rotating coil magnetometers, etc., may also be used in implementations of the mobile device in place of, or in addition to, the MEMS-based implementations. Thus, a magnetometer sensing device may be used to determine the direction of the earth's magnetic field (e.g., relative to an axes of the magnetometer device), and based on the measurement(s) from which the orientation of the magnetometer relative to the earth's true north is determined, the orientation of the receiver 110 relative to the true north (and/or relative to the direction of gravity) can also be determined (because the spatial relationship of the receiver's at least two antennas to an axis(es) of the magnetometer device is known).

In some embodiments, one of the one or more of the sensing devices 120a-n may include a gyroscope sensor. A gyroscope sensor may be implemented, in some embodiments, using MEMS technology, and may be a single-axis gyroscope, a double-axis gyroscope, or a 3-D gyroscope, configured to sense motion about, for example, three orthogonal axes. Other types of gyroscopes may be used in place of, or in addition to MEMS-based gyroscope. Gyroscopes enable tracking of attitude, and can improve knowledge of a receiver's/device's orientation, thus facilitating derivation of an angle of arrival of a signal and/or an elevation value (with an associated uncertainty value).

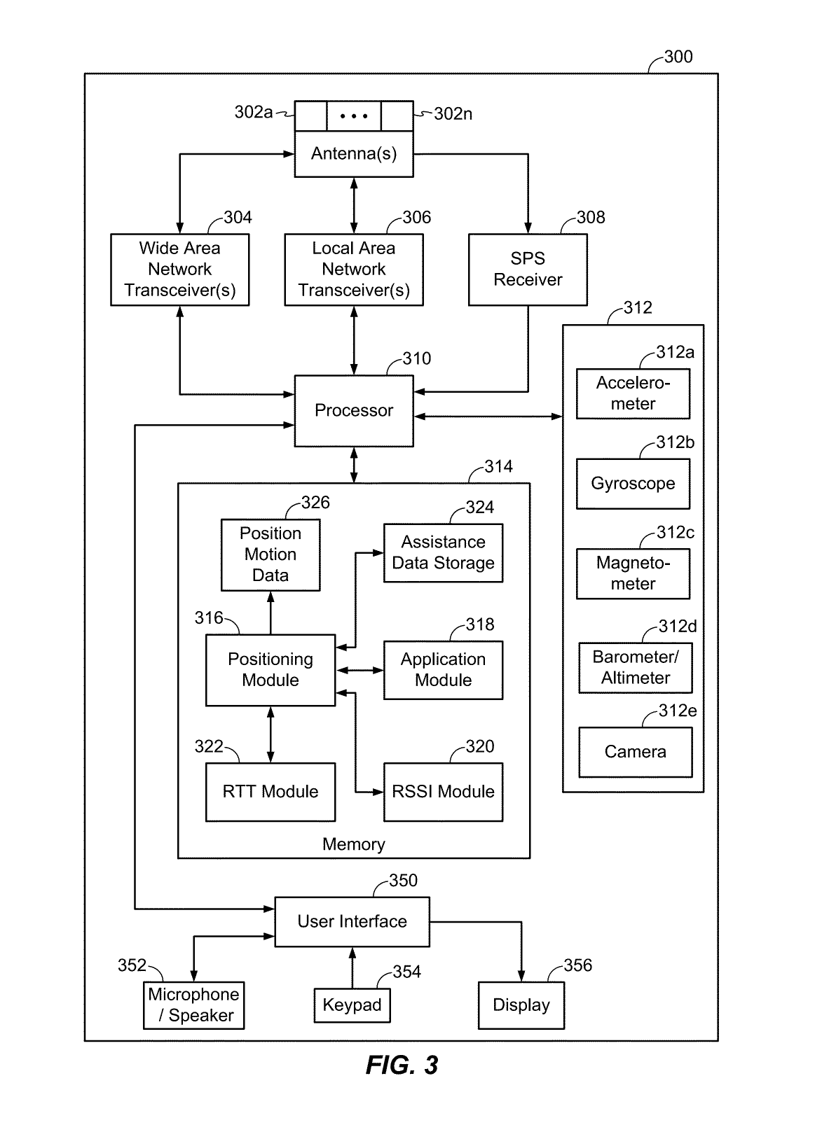

In some embodiments, determining the orientation of device may include capturing an image of a scene viewable from the receiver by an image capturing unit (e.g., a CCD camera, not shown in FIG. 1, but schematically shown in FIG. 3) coupled to the receiver, and determining the orientation of the receiver based, at least in part, on the image data. In some embodiments, features in a scene (whose orientation in a real world frame of reference is known or can be estimated) can be identified in an image of the scene captured by the image capturing device. For example, text of a traffic sign (e.g., “EXIT,” “STOP,” etc.) that are known to generally be oriented perpendicularly to a terrain (and thus the signs' orientation relative to the direction of gravity may be determined) can be identified. The orientation of those identified features in the captured image may then be computed, and based on the features' orientation in the image and in the real-world, the orientation of the camera (and thus of the device's antennas) relative to a real-world frame of reference may be derived, thus enabling determination of such information as the direction (exact or approximated) of the signal arriving at the device. For example, in some embodiments, the center of an image feature (e.g., represented in terms of pixels) and a vector indicating the direction of the feature (e.g., also in term of pixels) can be determined. These parameters can then be used to derive the camera's pitch angle, which can be used to determine components of attitude. Image data-based orientation computations may be used as a weak indicator of orientation, which may be combined with other information to determine the receiver's orientation.

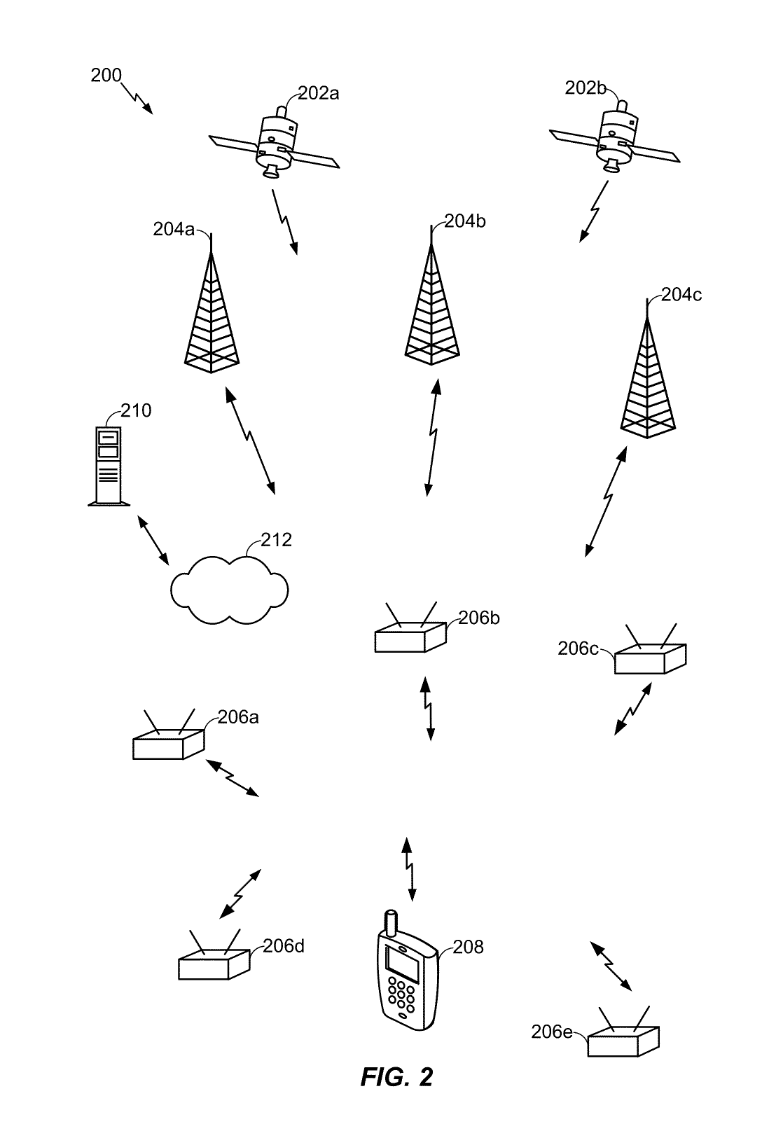

The determined direction at which a signal, such as the signal 132 transmitted from the wireless node 130, arrives at a receiver, such as the receiver 110 depicted in FIG. 1, may be used, in conjunction with other determined information such as location information for the receiver 110, to perform various functions and processes. For example, based a determined location of the receiver, multi-path analysis of the signal(s) received by the receiver may be performed to, for instance, determine if the received signal corresponds to a line-of-sight signal sent by a source transmitter, or corresponds to a copy of the signal arriving at the receiver (from the source transmitter) through an indirect path (e.g., reflection). Thus, with reference to FIG. 2, a schematic diagram of an example operating environment 200 is shown, in which a mobile device 208 operates, e.g., a mobile device configured to perform location determination facilitated, in part, by signals received from one or more transmitting wireless devices (e.g., terrestrial access points, satellites). The mobile device 208 and which includes a receiver, such as the receiver 110 of FIG. 1, configured to determine direction at which a signal(s) from at least one of the transmitters depicted in FIG. 2 arrives at the receiver. Information about signal direction and location of mobile device (or its receiver) can then be leveraged to perform various other operations and processes.

The mobile device (also referred to as a wireless device or as a mobile station) 208 may be configured, in some embodiments, to operate and interact with multiple types of communication systems/devices, including local area network devices (or nodes), such as WLAN for indoor communication, femtocells, Bluetooth® wireless technology-based transceivers, and other types of indoor communication network nodes, wide area wireless network nodes, satellite communication systems, etc., and as such the mobile device 128 may include one or more interfaces to communicate with the various types of communications systems. As used herein, communication systems/devices/transmitters/nodes with which the mobile device 208 may communicate are also referred to as access points (AP's).

As noted, the environment 200 may contain one or more different types of wireless communication systems or nodes. Such nodes (e.g., wireless access points, or WAPs) may include LAN and/or WAN wireless transceivers, including, for example, WiFi base stations, femto cell transceivers, Bluetooth® wireless technology transceivers, cellular base stations, WiMax transceivers, etc. Thus, for example, and with continued reference to FIG. 2, the environment 200 may include Local Area Network Wireless Access Points (LAN-WAPs) 206a-e that may be used for wireless voice and/or data communication with the mobile device 208. The LAN-WAPs 206a-e may also be utilized, in some embodiments, as independents sources of position data, e.g., through fingerprinting-based procedures, through implementation of multilateration-based procedures based, for example, on timing-based techniques (e.g., RTT-based techniques, etc.) The LAN-WAPs 206a-e can be part of a Wireless Local Area Network (WLAN), which may operate in buildings and perform communications over smaller geographic regions than a WWAN. Additionally, in some embodiments, the LAN-WAPs 206a-e could also be pico or femto cells. In some embodiments, the LAN-WAPs 206a-e may be part of, for example, WiFi networks (802.11x), cellular piconets and/or femtocells, Bluetooth® wireless technology Networks, etc. The LAN-WAPs 206a-e can also include a Qualcomm indoor positioning system (QUIPS). A QUIPS implementation may, in some embodiments, be configured so that a mobile device can communicate with a server that provides the device with data (such as to provide the assistance data, e.g., floor plans, AP MAC IDs, RSSI maps, etc.) for a particular floor or some other region where the mobile device is located. Although five (5) LAN-WAP access points are depicted in FIG. 2, any number of such LAN-WAP's may be used, and, in some embodiments, the environment 200 may include no LAN-WAPs access points at all, or may include a single LAN-WAP access point.

As further shown in FIG. 2, the environment 200 may also include a plurality of one or more types of Wide Area Network Wireless Access Points (WAN-WAPs) 204a-c, which may be used for wireless voice and/or data communication, and may also serve as another source of independent information through which the mobile device 208 may determine its position/location. The WAN-WAPs 204a-c may be part of wide area wireless network (WWAN), which may include cellular base stations, and/or other wide area wireless systems, such as, for example, WiMAX (e.g., 802.16). A WWAN may include other known network components which are not shown in FIG. 2. Typically, each WAN-WAPs 204a-204c within the WWAN may operate from fixed positions or may be moveable nodes, and may provide network coverage over large metropolitan and/or regional areas. Although three (3) WAN-WAPs are depicted in FIG. 2, any number of such WAN-WAPs may be used. In some embodiments, the environment 200 may include no WAN-WAPs at all, or may include a single WAN-WAP.

Communication to and from the mobile device 208 (to exchange data, enable position determination of the device 208, etc.) may be implemented, in some embodiments, using various wireless communication networks such as a wide area wireless network (WWAN), a wireless local area network (WLAN), a wireless personal area network (WPAN), and so on. The term “network” and “system” may be used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMax (IEEE 802.16), and so on. A CDMA network may implement one or more radio access technologies (RATs) such as cdma2000, Wideband-CDMA (W-CDMA), and so on. Cdma2000 includes IS-95, IS-2000, and/or IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may also be implemented, at least in part, using an IEEE 802.11x network, and a WPAN may be a Bluetooth® wireless technology network, an IEEE 802.15x, or some other type of network. The techniques described herein may also be used for any combination of WWAN, WLAN and/or WPAN.

In some embodiments, and as further depicted in FIG. 2, the mobile device 208 may also be configured to at least receive information from a Satellite Positioning System (SPS) 202a-b, which may be used as an independent source of position information for the mobile device 208. The mobile device 208 may thus include one or more dedicated SPS receivers specifically designed to receive signals for deriving geo-location information from the SPS satellites. Thus, in some embodiments, the mobile device 208 may communicate with any one or a combination of the SPS satellites 202a-b, the WAN-WAPs 204a-c, and/or the LAN-WAPs 206a-e. In some embodiments, each of the aforementioned systems can provide an independent information estimate of the position for the mobile device 208 using different techniques. In some embodiments, the mobile device may combine the solutions derived from each of the different types of access points to improve the accuracy of the position data. It is also possible to hybridize measurements from different systems to get a position estimate, particularly when there is an insufficient number of measurements from all individual systems to derive a position. For instance, in an urban canyon setting, only one GNSS satellite may be visible and provide decent measurements (i.e. raw pseudorange and Doppler observables). By itself, this single measurement cannot provide a position solution. However, it could be combined with measurements from urban WiFi APs, or WWAN cell ranges. When deriving a position using the access points 204a-b, 206a-e, and/or the satellites 202a-b, at least some of the operations/processing may be performed using a positioning server 210 which may be accessed, in some embodiments, via a network 212.

In embodiments in which the mobile device 208 can receive satellite signals, the mobile device may utilize a receiver (e.g., a GNSS receiver) specifically implemented for use with the SPS to extract position data from a plurality of signals transmitted by SPS satellites 202a-b. Transmitted satellite signals may include, for example, signals marked with a repeating pseudo-random noise (PN) code of a set number of chips and may be located on ground based control stations, user equipment and/or space vehicles. The techniques provided herein may be applied to or otherwise enabled for use in various other systems, such as, e.g., Global Positioning System (GPS), Galileo, Glonass, Compass, Quasi-Zenith Satellite System (QZSS) over Japan, Indian Regional Navigational Satellite System (IRNSS) over India, Beidou over China, etc., and/or various augmentation systems (e.g., a Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

As used herein, a mobile device or station (MS) refers to a device such as a cellular or other wireless communication device, personal communication system (PCS) device, personal navigation device (PND), Personal Information Manager (PIM), Personal Digital Assistant (PDA), a tablet device, a laptop, recreational navigational-capable sporting devices (e.g., a jogging/cycling equipped with a GPS and/or WiFI receiver), or some other suitable mobile device which may be capable of receiving wireless communication and/or navigation signals, such as navigation positioning signals. The term “mobile station” (or “mobile device”) is also intended to include devices which communicate with a personal navigation device (PND), such as by short-range wireless (e.g., Bluetooth® wireless technology), infrared, wireline connection, or other connection, regardless of whether satellite signal reception, assistance data reception, and/or position-related processing occurs at the device or at the PND. Also, “mobile station” is intended to include all devices, including wireless communication devices, computers, laptops, tablet, etc., which are capable of communication with a server, such as via the Internet, WiFi, or other network, regardless of whether satellite signal reception, assistance data reception, and/or position-related processing occurs at the device, at a server, or at another device associated with the network. Any operable combination of the above are also considered a “mobile station.”

With reference now to FIG. 3, a schematic diagram illustrating various components of an example mobile device 300, which may include or may be similar to the receiver 110 of FIG. 1 and/or the mobile device 208 of FIG. 2, is shown. For the sake of simplicity, the various features/components/functions illustrated in the box diagram of FIG. 3 are connected together using a common bus to represent that these various features/components/functions are operatively coupled together. Other connections, mechanisms, features, functions, or the like, may be provided and adapted as necessary to operatively couple and configure a portable wireless device. Furthermore, one or more of the features or functions illustrated in the example of FIG. 3 may be further subdivided, or two or more of the features or functions illustrated in FIG. 3 may be combined. Additionally, one or more of the features or functions illustrated in FIG. 3 may be excluded.

As shown, the mobile device 300 may include one or more local area network transceivers 306 that may be connected to one or more antennas 302a-n. As noted, in some embodiments, to determine the direction of a signal detected by a receiver or a mobile device, multiple antennas (e.g., at least two) are disposed on, or otherwise coupled to, the mobile device 300. The multiple antennas 302a-n are generally placed at known positions relative to the mobile device (e.g., positioned proximate opposing ends of one of the surfaces of the mobile device's housing), and thus are placed at a known position/orientation relative to one or more sensing device that may be used to determine the orientation of the mobile device (e.g., relative to a global frame of reference, such as a frame of reference where the direction of gravity is known). The one or more local area network transceivers 306 comprise suitable devices, hardware, and/or software for communicating with and/or detecting signals to/from the wireless transmitter 130 (depicted in FIG. 1), the LAN-WAPs 206a-e depicted in FIG. 2, and/or directly with other wireless devices within a network. In some embodiments, the local area network transceiver(s) 306 may comprise a WiFi (802.11x) communication transceiver suitable for communicating with one or more wireless access points; however, in some embodiments, the local area network transceiver(s) 306 may be configured to communicate with other types of local area networks, personal area networks (e.g., Bluetooth® wireless technology), etc. Additionally, any other type of wireless networking technologies may be used, for example, Ultra Wide Band, ZigBee, wireless USB, etc. In some embodiments, the unit 306 may be a receiver-only communication unit that can receive signals (e.g., to enable navigational functionality) but cannot transmit signals.

The mobile device 300 may also include, in some implementations, one or more wide area network transceiver(s) 304 that may be connected to the at least two antennas 302a-n. The wide area network (WAN) transceiver 304 may comprise suitable devices, hardware, and/or software for communicating with, and/or detecting signals from, the transmitter/node 130 (e.g., in embodiments in which the transmitter 130 is configured to serve as a WAN transmitter), from one or more of the WAN-WAPs 204a-c illustrated in FIG. 2, and/or directly with other wireless devices within a network. In some implementations, the wide area network transceiver(s) 304 may comprise a CDMA communication system suitable for communicating with a CDMA network of wireless base stations. In some implementations, the wireless communication system may comprise other types of cellular telephony networks, such as, for example, TDMA, GSM, etc. Additionally, any other type of wireless networking technologies may be used, including, for example, WiMax (802.16), etc. In some embodiments, a receiver-only communication unit may be used in place of the transceiver 304 in order to receive signals (e.g., to enable navigational functionality) but without transmitting signals.

In some embodiments, an SPS receiver (also referred to as a global navigation satellite system (GNSS) receiver) 308 may also be included with the mobile device 300. The SPS receiver 308 may be connected to the one or more antennas 302 for receiving satellite signals. The SPS receiver 308 may comprise any suitable hardware and/or software for receiving and processing SPS signals. The SPS receiver 308 may request information as appropriate from the other systems, and may perform the computations necessary to determine the position of the mobile device 300 using, in part, measurements obtained by any suitable SPS procedure.

In some embodiments, the mobile device 300 may also include one or more sensors 312 coupled to a processor 310. For example, the sensors 312 may include inertial sensors (also referred to as motion or orientation sensors) to provide relative movement and/or orientation information which is independent of motion data derived from signals received by the wide area network transceiver(s) 304, the local area network transceiver(s) 306, and/or the SPS receiver 308. Based on measurements from one or more of the device's sensors, the orientation of the device (and thus of the antennas, whose position and orientation relative to the position/orientation of the one or more sensors is known) relative to an external (i.e., external to the device 300) frame of reference can be derived. As described herein, based on the orientation of the antennas derived using measurement(s) from the one or more of the sensors, and based further on the phase difference determined from measurement of a signal detected by at least two of the multiple antennas 302a-n, a direction of a signal arriving at the device (e.g., a direction relative to a line defined by the at least two of the multiple antennas 302a-n and/or a direction relative to a global frame or of reference) may be derived.

By way of example but not limitation, the inertial sensors may include an accelerometer 312a, a gyroscope 312b, a geomagnetic (magnetometer) sensor 312c (e.g., a compass), an altimeter (e.g., a barometric pressure altimeter) 312d, and/or other sensor types. As noted, in some embodiments, the accelerometer 312a may be a 3-D accelerometer, which may be implemented based on three individual 1-D accelerometer realized, for example, using MEMS technology. In some embodiments, the gyroscope 312b may include a gyroscope based on MEMS technology, and may be a single-axis gyroscope, a double-axis gyroscope, or a 3-D gyroscope configured to sense motion about, for example, three orthogonal axes. Other types of gyroscopes may be used in place of, or in addition to MEMS-based gyroscope. As further noted, in some embodiments, a magnetometer, configured to measure a magnetic field intensity and/or direction may also be implemented based on MEMS technology. In some embodiments, the altimeter 312d may, for example, be configured to provide altitude data and thus may facilitate determining a floor in an indoor structure (e.g., a shopping mall) where the device may be located. Based on data representative of altitude measurements performed by the altimeter, navigation tasks, such as obtaining assistance data (including maps) for a particular floor in the indoor structure may be performed. In some embodiments, absolute altitude may be available when a reference barometer, at a known nearby location (e.g., in the same building where the mobile device 300 is located) is available. When such a reference barometer is not available, a barometer can provide change of altitude information, which can be used in conjunction with information from inertial sensors (e.g., the accelerometer, gyroscope, etc.) to, for example, determine a position estimate. When a reference barometer is not available, absolute altitude may be determined based on determination of the direction of a signal received by the device 300 (as will be described in greater details below).

The output of the one or more sensors 312 may be used to determine the orientation of the device 300 relative to an external frame of reference. For example, as described herein, measurements performed by the accelerometer 312a may provide values representative of the direction of gravity, which can then be used to provide a value representative of the tilt of the device 300 relative to the direction of gravity. In some embodiments, the outputs of the one or more sensors 312a-d may also be combined in order to provide motion information. For example, estimated position of the mobile device 300 may be determined based on a previously determined position and the distance traveled from that previously determined position as determined from the motion information derived from measurements by at least one of the one or more sensors. In some embodiments, the estimated position of the mobile device may be determined based on probabilistic models (e.g., implemented through a particle filter, leveraging, for example, motion constraints established by venue floor plans) using the outputs of the one or more sensors 312.

As further shown in FIG. 3, in some embodiments, the one or more sensors 312 may also include a camera 312e (e.g., a charge-couple device (CCD)-type camera), which may produce still or moving images (e.g., a video sequence) that may be displayed on a user interface device, such as a display or a screen. As noted, in some embodiments, the orientation of the device 300 (relative to an external frame of reference) may be determined based on image data captured by a camera such as the camera 312e. For example, features in a scene, whose orientations in a real world frame of reference are known or can be estimated (e.g., text of a traffic sign located in a terrain substantially perpendicular to the direction of gravity can likewise be estimated to be substantially perpendicular to the direction of gravity), can be identified in an image of the scene captured by the camera 312e. The orientation of those identified features in the captured image (i.e., in the camera's frame of reference) can be computed, and based on the features' orientations in the image and in the local-level frame of reference, components of the orientation (e.g., elevation and roll) of the camera (and thus of the device's antennas) relative to the real-world frame of reference can be derived, thus enabling determination of such information as the direction (exact or approximated) of a signal arriving at the device.

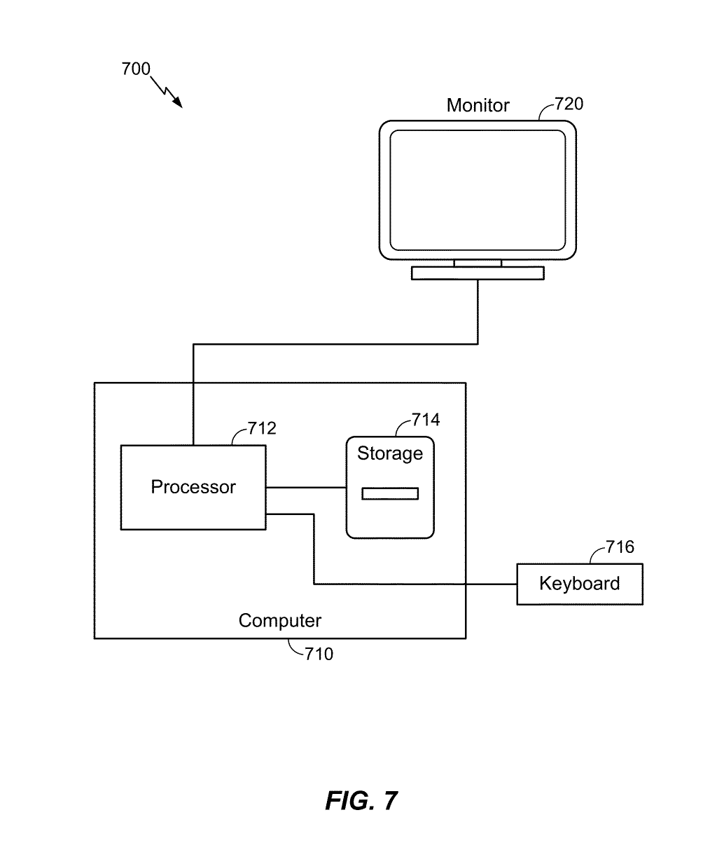

The processor(s) (also referred to as a controller) 310 may be connected to the local area network transceiver(s) 306, the wide area network transceiver(s) 304, the SPS receiver 308, and/or the one or more sensors 312. The processor may include one or more microprocessors, microcontrollers, and/or digital signal processors that provide processing functions, as well as other calculation and control functionality. In some embodiments, a controller may be implemented without use of a processing-based device. The processor 310 may also include storage media (e.g., memory) 314 for storing data and software instructions for executing programmed functionality within the mobile device. The memory 314 may be on-board the processor 310 (e.g., within the same IC package), and/or the memory may be external memory to the processor and functionally coupled over a data bus. Further details regarding an example embodiment of a processor or computation system, which may be similar to the processor 310, are provided below in relation to FIG. 7.

A number of software modules and data tables may reside in the memory 314 and be utilized by the processor 310 in order to manage both communications with remote devices/nodes (such as the various access points depicted in FIG. 2), positioning determination functionality, and/or device control functionality. As described herein, the processor 310 may also be configured, e.g., using software-based implementations, to determine a phase difference corresponding to a signal received from a transmitting node and detected by at least two antennas (e.g., at least two of the antennas 302a-n) coupled to the device 300, determine an orientation of the device (e.g., relative to some external frame of reference), and determine a direction of the detected signal (e.g., angle of arrival of the signal relative to, for example, a line defined by the at least two antennas detecting the received signal).

As further illustrated in FIG. 3, the memory 314 may also include a positioning module 316, an application module 318, a received signal strength indicator (RSSI) module 320, and/or a round trip time (RTT) module 322. It is to be noted that the functionality of the modules and/or data structures may be combined, separated, and/or be structured in different ways depending upon the implementation of the mobile device 300. For example, the RSSI module 320 and/or the RTT module 322 may each be realized, at least partially, as a hardware-based implementation, and may thus include such devices as a dedicated antenna (e.g., a dedicated RTT and/or RSSI antenna), a dedicated processing unit to process and analyze signals received and/or transmitted via the antenna(s) (e.g., to determine signal strength of a received signals, determine timing information in relation to an RTT cycle), etc.

The application module 318 may be a process running on the processor 310 of the mobile device 300, which requests position information from the positioning module 316. Applications typically run within an upper layer of the software architectures, and may include indoor navigation applications, shopping applications, location-aware service applications, etc. For example, the application module 318 may include applications to determine a floor of an indoor structure where the mobile device 300 is located, to perform multi-path rejection (e.g., to disregard copies, such as signals reflection, of a primary signal), etc., based on signal direction information derived from the device's determined orientation and a determined phase difference of received signals.

The positioning module 316 may derive the position of the mobile device 300 using information derived from various receivers and modules of the mobile device 300. For example, the position of the device 300 may be determined based on round trip time (RTT) measurements performed by the RTT module 322, which can measure the timings of signals exchanged between the mobile device 300 and an access point(s) to derive round trip time information. The position of the device 300 may also be determined, in some embodiments, based on received signal strength indication (RSSI) measurements performed by the RSSI module 320.

As further illustrated, the mobile device 300 may also include assistance data storage module 324 where assistance data may be stored, including data such as map information, data records relating to location information in an area where the device is currently located, etc. Such assistance data may have been downloaded from a remote server. In some embodiments, the mobile device 300 may also be configured to receive supplemental information that includes auxiliary position and/or motion data which may be determined from other sources (e.g., the sensors 312), and store it in an auxiliary position/motion data unit 326. Supplemental information may also include, but are not limited to, information that can be derived or based upon Bluetooth® wireless technology signals, beacons, RFID tags, and/or information derived from a map (e.g., receiving coordinates from a digital representation of a geographical map by, for example, a user interacting with a digital map).

The mobile device 300 may further include a user interface 350 which provides a suitable interface system, such as a microphone/speaker 352, keypad 354, and a display 356 that allows user interaction with the mobile device 300. The microphone/speaker 352 provides for voice communication services (e.g., using the wide area network transceiver(s) 304 and/or the local area network transceiver(s) 306). The keypad 354 comprises suitable buttons for user input. The display 356 comprises a suitable display, such as, for example, a backlit LCD display, and may further include a touch screen display for additional user input modes.

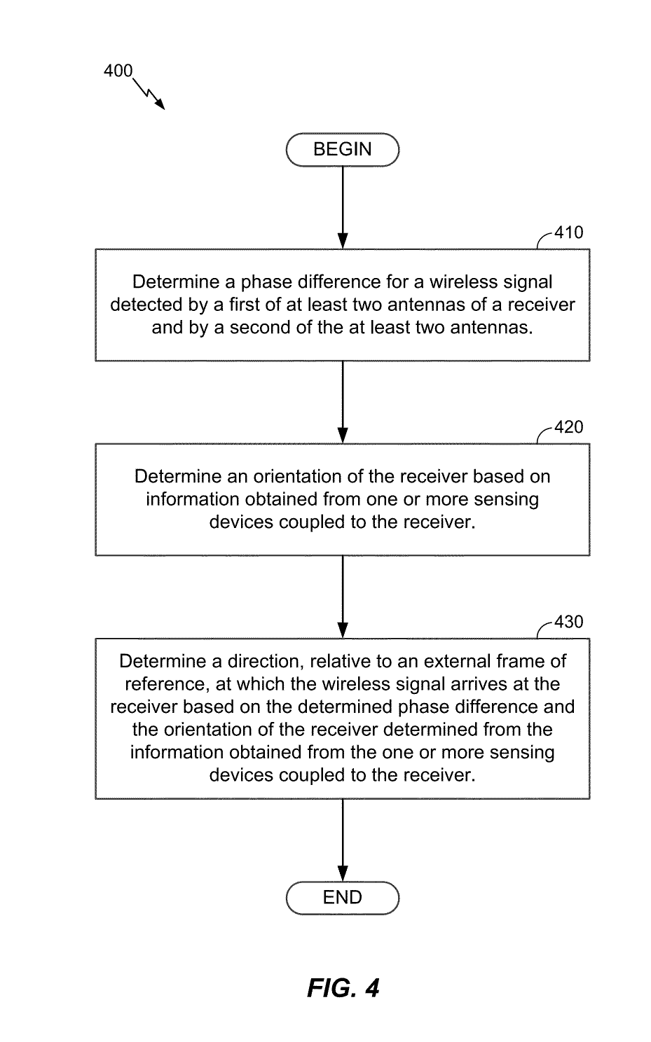

With reference now to FIG. 4, a flowchart of an example procedure 400 to determine signal direction is shown. The procedure 400 includes determining 410 a phase difference for a wireless signal detected by a first of at least two antennas (e.g., the antenna 112 depicted in FIG. 1) of a receiver (e.g., the receiver 110 of FIG. 1) and by a second of the at least two antennas (e.g., the antenna 114). The procedure 400 further includes determining 420 an orientation of the receiver based on information obtained from one or more sensing devices coupled to the receiver. For example, as noted, in some embodiments, the orientation of the receiver may be determined using an accelerometer to determine the direction of gravity (e.g., when the receiver is stationary, and the only force acting on it is gravity). Because, in such embodiments, the position/orientation of the accelerometer relative to the antennas that detected the signal are known, the direction of gravity relative to the antenna's positions can be derived. As further noted, in some embodiments, the orientation of the receiver may be derived/determined based on measurements from other types of sensing devices, such as magnetometers, gyroscopes, etc., as well as based on image data captured by an image capturing device. For example, an onboard CCD camera may capture an image viewable from the receiver, and process the image to, for example, identify various features whose orientation in real world coordinates is known or can be reasonably established (e.g., text appearing in traffic signs located in a substantially flat terrain may be assumed to be oriented substantially perpendicularly to the direction of gravity). Based on measurements from which the orientation of the devices can be derived, and based further on the known spatial relationship of the sensing devices (be it an inertial sensing device, an image capturing unit, etc.) to the receiver to which these sensing devices are coupled or are housed in, the orientation of the receiver (relative to an external frame of reference) may be derived/determined.

Having determined the phase difference for the signal (transmitted from some transmitting node, such as the node 130 of FIG. 1) and the orientation of the receiver relative to an external frame of reference (e.g., relative to the direction of gravity), the direction at which the wireless signal (detected by the at least two antennas) arrives at the receiver is determined 430 based on the determined phase difference and the determined orientation of the receiver.

As noted, in situations where the orientation of a line passing between the at least two antennas of the receiver is substantially parallel to the direction of gravity (as determined, for example, through a measurement performed by an accelerometer), the direction of the signal arriving from a transmitting node (such as the transmitter 130 depicted in FIG. 1) will be substantially equal to the elevation angle. However, in situation in which the orientation of the receiver (or more particularly, the orientation of the line passing between the at least two antennas) is not parallel to the direction of gravity, the direction of the arriving signal (e.g., the elevation angle) determined from the computed phase difference and the orientation value obtained from measurements with the receiver's one or more sensing devices, will be associated with an uncertainly value. This uncertainty value is representative of a degree of potential error between the direction of the signal that is computed by the receiver, and the actual direction of the signal. In some embodiments, this uncertainty error may be proportional to an angle between the line passing between the at least two antennas, and a zenith in a horizontal coordinate system (where the zenith is computed 90°−elevation angle, i.e., 90°−θ). Thus, the more the receiver is tilted or skewed relative to the direction of gravity, the larger the uncertainty that will be associated with the elevation angle (e.g., when the azimuth of the device cannot be resolved).

As noted, the signal direction, determined based on a computed phase difference for a signal detected by at least two separate antennas, and a determined orientation of a receiving device, may be combined or used with other information (e.g., location information for the receiving device) to determine various additional values and/or perform various additional functions. For example, in some embodiments, the determined signal's direction (vis-à-vis the receiving device) may be used in conjunction with determined location information to determine altitude information (including determination of a floor on which the receiving device may be located, in situation in which the device is inside an indoor structure).

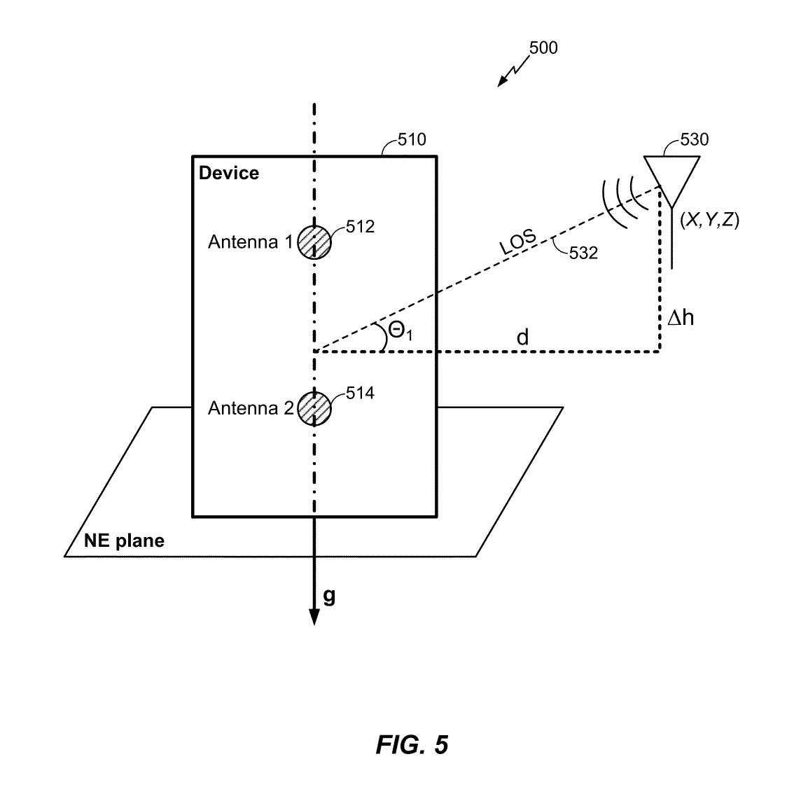

Consider the example environment 500 depicted in FIG. 5, which includes a device 510 (which may be similar to, or include, the receiver 110 illustrated in FIG. 1) receiving signals from a transmitting node 530 (e.g., a WiFi node). Assume further that the (x,y) coordinates of the receiver are known or can be determined/estimated (e.g., through one or more location determination procedures), and that the only unknown is the altitude of the device 510, or the particular floor, out of a plurality of floors, in an indoor structure where the device 510 is located. In the example of FIG. 5, the device 510 may include at least two antennas that are separated by at least a distance of λ/4 (where λ is the wavelength of the signal 532 transmitted by the node 530). In this situation, the device 510 is configured to detect the signal 532 at its at least two antennas, and based on measurements performed on the detected signals, the phase difference resulting from the detection of the signal at the two spatially separated antennas can be computed. Additionally, one or more sensing devices coupled to, or housed on, the device 510 can be used to take measurements, based on which the device's orientation (e.g., relative to the direction of gravity, or some other external frame of reference) may be derived. Based on these computed values of the phase difference and the device's spatial orientation, the direction of the signal 532, and thus the elevation angle θ₁ for the device 510 with respect to the transmitter 530, may be computed. For example, when the device is oriented so that a line passing between the device's at least two antennas is substantially parallel to the direction gravity, the angle corresponds directly to the elevation angle, θ₁. Because the coordinates (X, Y, Z) of the transmitter 530 are known, the altitude of the device 510 can be determined using the height difference, Δh, between the node 530 and the device 510 (which may be computed according to Δh=d tan(θ₁), where d is the horizontal distance between the node 530 and the device 510). The determined altitude for the device 510 can also be used to determine the floor, in an indoor structure, where the device 510 is located.

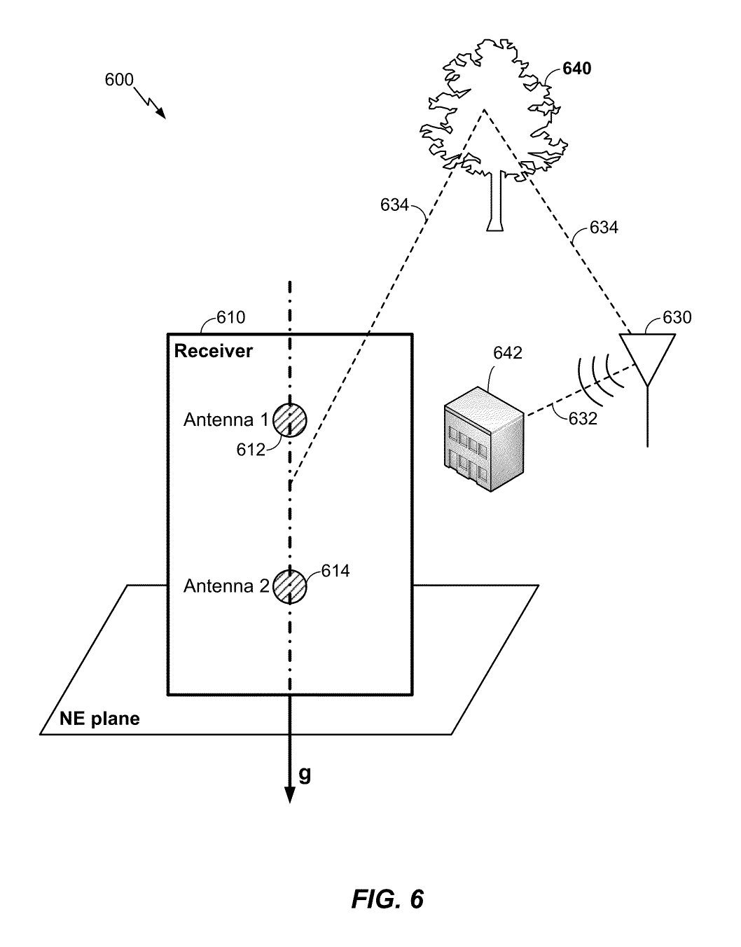

The direction that a signal arrives at a receiver device (e.g., relative to an external frame of reference) may also be used for performing multi-path analysis and reject signals that may be reflections of a line-of-sight source signal. For example, FIG. 6 is a schematic diagram of showing an environment that includes a receiver 610 (which may be similar to the receiver 110, the devices 208, 300, and/or the receiver device 510, of FIGS. 1, 2, 3, and 5, respectively) receiving signals transmitted from a transmitter/node 630. As illustrated in FIG. 6, the receiver 610, which includes at least two antennas 612 and 614, does not have a direct line of sight path to the transmitter 630 (e.g., because the direct path is obstructed by, for example, a structure such as a building 642), and thus cannot receive a line-of-sight signal 632 directly from the transmitter 630. However, the transmitter 630 may be configured to transmit signals in multiple directions (e.g., the transmitter may include multiple antennas or antenna arrays, or may be equipped with an omni-directional antenna), and consequently, a signal transmitted by the transmitter 630 may propagate in multiple directions, and at least another copy or instance of the signal 632 (e.g., the signal labeled 634 in FIG. 6) may arrive at, and be detected by, the receiver 610. In the example of FIG. 6, the signal 634 may arrive at an object such as a tree 640, and may be reflected towards the receiver 610. The receiver 610 may perform signal processing on the signal 634 to determine the direction of arrival of the signal 634. When the location of the transmitter 630 and the receiver 610 are known, the determined direction (e.g., relative to the external frame of reference) of the signal 634 can be compared to the expected angle of arrival for signals arriving directly from the transmitter 630, to thus determine that the signal 634 corresponds to a copy of the signal transmitted by the transmitter 630 that did not arrive directly from the transmitter 630. Based on that determination, the signal 634 may be rejected, or otherwise may be accounted for (e.g., to perform various functions using signals received from multiple paths). To further illustrate, in an example where the transmitter 630 is a satellite transmitter, the direction (elevation) of arrival should generally be constant for a receiving device, and if a different elevation is derived (e.g., according to the procedures described herein), then it is possibly because a different multipath component was detected by the receiver. Thus, in some embodiments, the procedures described herein may be used for determining, based on the direction at which a wireless signal arrives at the receiver, whether that wireless signal is a reflection of a source signal (e.g., a source signal such as the signal 632).

In some embodiments, an effective antenna pattern for the at least two antennas of a receiver may be modified based on the determined direction at which a wireless signal arrives at the receiver. The effective antenna pattern can be changed by adding a phase offset between the two (or more) antennas before their I/Q samples are summed For example, if the phase offset is zero and the antennas are separated by λ/4, the signals arriving at 90° with respect to the axis of sensitivity are amplified, and signals that arrive at 0 degrees with respect to the axis of sensitivity are almost completely cancelled. If the phase offset introduced in processing were λ/4, then the signal at 0 degrees would be amplified and there would be a null at 90°.

Performing the procedures described herein, including the procedures to determine phase difference, device orientation, and direction a signal arrives at a device that has at least two antennas, may be facilitated by a processor-based computing system. With reference to FIG. 7, a schematic diagram of an example computing system 700 is shown. The computing system 700 may be used to realize, for example, a device/receiver such as the devices/receivers 110, 208, 300, 510, and 610 of FIGS. 1, 2, 3, 5, and 6, respectively, and/or a transmitter/node/AP, such any one of the transmitters/nodes/AP's 130, 202a-b, 204a-c, 206a-e, 530, and 630 depicted in FIGS. 1, 2, 5, and 6, respectively. The computing system 700 includes a processor-based device 710 such as a personal computer, a specialized computing device, and so forth, that typically includes a central processor unit 712. In addition to the CPU 712, the system includes main memory, cache memory and bus interface circuits (not shown). The processor-based device 710 may include a mass storage device 714, such as a hard drive and/or a flash drive associated with the computer system. The computing system 700 may further include a keyboard, or keypad, 716, and a monitor 720, e.g., a CRT (cathode ray tube) or LCD (liquid crystal display) monitor, that may be placed where a user can access them (e.g., a mobile device's screen).

The processor-based device 710 is configured to, for example, implement the procedures described herein, including procedures to determine direction that a signal arrives at a receiver device based on a determined phase difference corresponding the detection of the signal by at least two antennas of the device, and based on a determined orientation of the receiver device (determined based on measurements by one or more sensing devices). The mass storage device 714 may thus include a computer program product that when executed on the processor-based device 710 causes the processor-based device to perform operations to facilitate the implementation of the above-described procedures.

The processor-based device may further include peripheral devices to enable input/output functionality. Such peripheral devices may include, for example, a CD-ROM drive and/or flash drive, or a network connection, for downloading related content to the connected system. Such peripheral devices may also be used for downloading software containing computer instructions to enable general operation of the respective system/device. Alternatively and/or additionally, in some embodiments, special purpose logic circuitry, e.g., an FPGA (field programmable gate array), a DSP processor, or an ASIC (application-specific integrated circuit) may be used in the implementation of the computing system 700. Other modules that may be included with the processor-based device 710 are speakers, a sound card, a pointing device, e.g., a mouse or a trackball, by which the user can provide input to the computing system 700. The processor-based device 710 may include an operating system.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” may refer to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

Memory may be implemented within the processing unit or external to the processing unit. As used herein the term “memory” refers to any type of long term, short term, volatile, nonvolatile, or other memory and is not to be limited to any particular type of memory or number of memories, or type of storage media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

At least some of the subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an embodiment of the subject matter described herein), or any combination of such back-end, middleware, or front-end components. The components of the system may be interconnected by any form or medium of digital data communication.

The computing system may include clients and servers. A client and server are generally remote from each other and typically interact through a communication network. The relationship of client and server generally arises by virtue of computer programs running on the respective computers and having a client-server relationship to each other.

Although particular embodiments have been disclosed herein in detail, this has been done by way of example for purposes of illustration only, and is not intended to be limiting with respect to the scope of the appended claims, which follow. In particular, it is contemplated that various substitutions, alterations, and modifications may be made without departing from the spirit and scope of the invention as defined by the claims. Other aspects, advantages, and modifications are considered to be within the scope of the following claims. The claims presented are representative of the embodiments and features disclosed herein. Other unclaimed embodiments and features are also contemplated. Accordingly, other embodiments are within the scope of the following claims.

What is claimed is:

1. A method comprising:
determining a phase difference for a wireless signal detected by a first of at least two antennas of a receiver and by a second of the at least two antennas;
determining an orientation of the receiver based on information obtained from one or more sensing devices coupled to the receiver; and
determining a direction, relative to an external frame of reference, at which the wireless signal arrives at the receiver based on the determined phase difference and the orientation of the receiver determined from the information obtained from the one or more sensing devices coupled to the receiver.

2. The method of claim 1, wherein determining the orientation of the receiver comprises:
obtaining a measurement indicative of the orientation of the receiver from an inertial sensor comprising one or more of: an accelerometer, a magnetometer, a gyroscope, or any combination thereof.

3. The method of claim 1, wherein the one or more sensing devices comprises an image capturing unit, and wherein determining the orientation of the receiver comprises:
capturing an image of a scene by the image capturing unit;
identifying one or more features, appearing in the captured image, associated with known orientations relative to a frame of reference; and
determining the orientation of the receiver based, at least in part, on the known orientations, relative to the frame of reference, respectively associated with the one or more identified features, and based on respective image orientations of the identified one or more features relative to another frame of reference associate with the image capturing unit.

4. The method of claim 1, wherein the wireless signal comprises one of: a satellite signal, or a terrestrial wireless signal from a terrestrial access point.

5. The method of claim 1, wherein determining the direction, relative to the external frame of reference, at which the wireless signal arrives at the receiver comprises:
determining an angle of elevation between the receiver and a wireless node transmitting the wireless signal; and
determining an uncertainty value associated with the determined angle of elevation based on the orientation of the receiver determined based on the information obtained from the one or more sensing devices.

6. The method of claim 5, wherein the uncertainty value is proportional to an angle between a line defined by the first and second of the at least two antennas, and a zenith in a horizontal coordinate system.

7. The method of claim 1, wherein the orientation of the receiver is indicated with respect to a line defined by the first and second of the at least two antennas.

8. The method of claim 1, wherein the receiver and the one or more sensing devices are housed in a wireless device.

9. The method of claim 1, further comprising:
determining, based on the direction, relative to the external frame of reference, at which the wireless signal arrives at the receiver and on location information for the receiver, whether the wireless signal is a reflection of a source signal.

10. The method of claim 1, further comprising:
determining, based on the direction, relative to the external frame of reference, at which the wireless signal arrives at the receiver, a current floor within a multi-floor building where the receiver is located.

11. The method of claim 1, further comprising:
determining, based on the direction, relative to the external frame of reference, at which the wireless signal arrives at the receiver and on location information for the receiver, an altitude at which the receiver is located.

12. The method of claim 1, further comprising:
modifying an effective antenna pattern for the at least two antennas of the receiver based on the determined direction, relative to the external frame of reference, at which the wireless signal arrives at the receiver.

13. A mobile device comprising:
one or more sensing devices;
a receiver including at least two antennas; and
a controller configured to, when operating, cause operations comprising:
determining a phase difference for a wireless signal detected by a first of the at least two antennas of the receiver and by a second of the at least two antennas;
determining an orientation of the receiver based on information obtained from the one or more sensing devices coupled to the receiver; and
determining a direction, relative to an external frame of reference, at which the wireless signal arrives at the receiver based on the determined phase difference and the orientation of the receiver determined from the information obtained from the one or more sensing devices coupled to the receiver.

14. The mobile device of claim 13, wherein the one or more sensing devices comprise one or more of: an accelerometer, a magnetometer, a gyroscope, or any combination thereof.

15. The mobile device of claim 13, wherein the one or more sensing devices comprises an image capturing unit, and wherein determining the orientation of the receiver comprises:
capturing an image of a scene by the image capturing unit;
identifying one or more features, appearing in the captured image, associated with known orientations relative to a frame of reference; and
determining the orientation of the receiver based, at least in part, on the known orientations, relative to the frame of reference, respectively associated with the one or more identified features, and based on respective image orientations of the identified one or more features relative to another frame of reference associate with the image capturing unit.

16. The mobile device of claim 13, wherein determining the direction, relative to the external frame of reference, at which the wireless signal arrives at the receiver comprises:
determining an angle of elevation between the receiver and a wireless node transmitting the wireless signal; and
determining an uncertainty value associated with the determined angle of elevation based on the orientation of the receiver determined based on the information obtained from the one or more sensing devices.

17. A processor readable media programmed with an instruction set executable on a processor that, when executed on the processor, causes operations comprising:
determining a phase difference for a wireless signal detected by a first of at least two antennas of a receiver and by a second of the at least two antennas;
determining an orientation of the receiver based on information obtained from one or more sensing devices coupled to the receiver; and
determining a direction, relative to an external frame of reference, at which the wireless signal arrives at the receiver based on the determined phase difference and the orientation of the receiver determined from the information obtained from the one or more sensing devices coupled to the receiver.

18. The processor readable media of claim 17, wherein determining the orientation of the receiver comprises:
obtaining a measurement indicative of the orientation of the receiver from an inertial sensor comprising one or more of: an accelerometer, a magnetometer, a gyroscope, or any combination thereof.

19. The processor readable media of claim 17, wherein the one or more sensing devices comprises an image capturing unit, and wherein determining the orientation of the receiver comprises:
capturing an image of a scene by the image capturing unit coupled to the receiver;
identifying one or more features, appearing in the captured image, associated with known orientations relative to a frame of reference; and
determining the orientation of the receiver based, at least in part, on the known orientations, relative to the frame of reference, respectively associated with the one or more identified features, and based on respective image orientations of the identified one or more features relative to another frame of reference associate with the image capturing unit.

20. The processor readable media of claim 17, wherein determining the direction, relative to the external frame of reference, at which the wireless signal arrives at the receiver comprises:
determining an angle of elevation between the receiver and a wireless node transmitting the wireless signal; and
determining an uncertainty value associated with the determined angle of elevation based on the orientation of the receiver determined based on the information obtained from the one or more sensing devices.
